(19) United States
(12) Patent Application Publication
(10) Pub. No.: US 2007/0232107 A1
(43) Pub. Date: Oct. 4, 2007

(54) Cap attachment structure, semiconductor sensor device and method

(75) Inventors: Kazuhiko Sugiura, Nagoya-city (JP); Hirotsugu Funato, Nagoya-city (JP); Tetsuo Fujii, Toyohashi-city (JP); Yumi Maruyama, Kariya-city (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 11/723,431

(22) Filed: Mar. 20, 2007

(30) Foreign Application Priority Data
Apr. 3, 2006 (JP) 2006-101929
Apr. 7, 2006 (JP) 2006-106185
Dec. 6, 2006 (JP) 2006-329597

(51) Int. Cl. H01R 33/02

(52) U.S. Cl. 439/226

(57) ABSTRACT

In an attachment structure, a protective cap is provided with an adhesion layer on its outer peripheral edge part and its internal surface. The protective cap is bonded and fixed to an adherend member through the adhesion layer. This attachment structure can be suitably used for a semiconductor device. Alternatively, in a semiconductor device, a protective cap can be bonded using an adhesive. In this case, an outer peripheral edge part of the protective cap has a first end positioned on its inner rim surface, and a second end positioned on its outer rim surface. Furthermore, the first end protrudes toward a sensor chip more than the second end, and is adjacent to the sensor chip.

### CROSS REFERENCE TO RELATED APPLICATION

This application is based on Japanese Patent Applications No. 2006-101929 filed on Apr. 3, 2006, No. 2006-106185 filed on Apr. 7, 2006 and No. 2006-329597 filed on Dec. 6, 2006, the contents of which are incorporated herein by reference in its entirety.

### BACKGROUND OF THE INVENTION

1. Field of the Invention

The present invention relates to a cap attachment structure in which a protective cap is attached to an adherend member. This invention also relates to a semiconductor sensor device including a sensor chip covered with a protective cap and a method of manufacturing the same.

2. Description of the Related Art

Conventionally, a micro device includes a movable structure that is fabricated with a MEMS (Micro Electro Mechanical Systems) technique and is formed on a surface of a substrate (wafer) as an adherend member, and a protective cap that is attached to the surface of the substrate to cover and protect the movable structure. The micro device is widely used for various sensor elements (e.g., an acceleration sensor, a pressure sensor and an ultrasonic sensor), a micro machine, and the like.

US 2004/0025589 A1 (corresponding to JP-A-2004-506203) discloses a micromechanical component including a substrate, a movable structure that is located on a surface of the substrate, a frame that is located on the surface of the substrate to surround the movable structure, and a protective cap that is connected to the frame by a connecting layer. As examples of the material for the connecting layer, US 2004/0025589 A1 describes an adhesive and a glass layer that are fused.

In a prior art, the protective cap is attached on the surface of the substrate in the following two methods.

As a method, an applying position of the adhesive is set to an outer peripheral edge part of the protective cap, and the adhesive is applied linearly or dotted to the outer peripheral part of the protective cap. Then, an attachment part of the protective cap is positioned relative to the surface of the substrate, and the outer peripheral edge part of the protective cap is pressed to the surface of the substrate so that the protective cap is bonded and fixed to the substrate by the adhesive.

As another method, an applying position of the adhesive is set to the surface of the substrate, and the adhesive is applied linearly or dotted to the applying position on the substrate. Then, an attachment part of the protective cap is positioned to the surface of the substrate, and the outer peripheral edge part of the protective cap is pressed to the surface of the substrate so that the protective cap is bonded and fixed to the substrate by the adhesive.

However, the above-described method has the following problems.

First, an accurate position is required to be set for two times, that is, when the adhesive is applied to the outer peripheral part of the protective cap or the surface of the substrate, and when the outer peripheral edge part of the protective cap is pressed to the surface of the substrate. Therefore, a production cost of the micro device becomes high in order to prevent displacements of the protective cap and the substrate and to improve a precision of the attachment of the protective cap.

When the outer peripheral edge part of the protective cap is pressed to the surface of the substrate, the adhesive may protrude or flow out from a contact portion between the outer peripheral edge part and the surface of the substrate. Therefore, a sufficient attachment area is needed to secure on the surface of the substrate so that the protruded or flown adhesive does not adhere to the movable structure, and a surface area of the substrate becomes large for the attachment area. As a result, the micro device is difficult to be miniaturized.

When the protective cap is attached to the substrate, dusts may enter an inside of the protective cap and adhere to the movable structure as foreign materials. In this case, the movable structure may be not movable freely, and a performance of the movable structure may be deteriorated.

When the movable structure moves, dusts may be generated from the movable structure and adhere to the movable structure as foreign materials. In this case, the movable structure may be not movable freely, and the performance of the movable structure is deteriorated.

When the protective cap is attached to the substrate and when the movable structure moves, a static electricity may be generated by the movable structure, and a static electricity may be generated in a vicinity of the micro device. When the static electricity affects the movable structure, the movable structure may be not movable freely, and the performance of the movable structure may be deteriorated.

Meanwhile, U.S. Pat. No. 6,255,741 (corresponding to JP-A-2000-31349) discloses a semiconductor sensor device including a sensor chip having a sensor structure composed of a semiconductor, and a protective cap covering the sensor chip. The protective cap has a concave part and arranged so that the concave part faces to the sensor structure. At a surrounding position of the concave part, a resin sheet applied with an adhesive is disposed. Therefore, the protective cap is bonded to the sensor chip having a sensor structure by the adhesive.

However, when the protective cap is pressed to be attached to the sensor chip, the adhesive applied to the resin sheet is protruded out to the inside of the protective cap, i.e., on a side of the sensor structure. In this case, the adhesive may enter the sensor structure and may cause a sticking of the sensor structure.

### SUMMARY OF THE INVENTION

In view of the foregoing problems, it is a first object of the present invention to provide a cap attachment structure in which a protective cap can be attached with a high accuracy and a low cost. A second object of the invention is to provide a compact cap attachment structure in addition to the first object. A third object of the invention is to provide a cap attachment structure that can prevent a performance deterioration of a movable structure covered with the protective cap, in addition to the first and second objects. A fourth object of the invention is to provide a semiconductor sensor device that can prevent a sticking of a sensor structure, and a method of manufacturing the same.

According to a first aspect of the invention, a cap attachment structure includes an adherend member, a protective cap fixed to the adherend member, and an adhesion layer. The protective cap has an outer peripheral edge part and an internal surface for defining an inner space, and the adhesion layer is provided on the outer peripheral edge part and the internal surface of the protective cap. The protective cap is bonded and fixed to the adherend member through the adhesion layer.

When the adhesion layer is formed on the outer peripheral edge part and the internal surface, a position of the adhesive for forming the adhesion layer is not required to be accurately set beforehand. Therefore, when the protective cap is attached to the adherend member, a position setting is required only for attaching the protective cap onto the adherend member. That is, the position setting is required for the one time.

Therefore, a number of the position setting can be reduced. As a result, according to the first aspect of the invention, in addition to prevent displacements of the protective cap and the adherend member, and to improve a precision of the attachment of the protective cap, the cap attachment structure can be provided at a low cost.

In the case that a movable structure is arranged on a surface of the adherend member, even if foreign materials such as dusts enter an attachment part of the movable structure on the adherend member, when the protective cap is attached and fixed to the adherend member through the adhesion layer, the foreign materials is bonded to the adhesion layer. The adhesion layer holds the foreign materials so that the foreign materials cannot drop off, thereby the foreign materials are trapped by the adhesion layer. Therefore, the possibility that the foreign materials having entered the attachment part of the movable structure on the adherend member adheres to the movable structure is reduced, and the foreign materials do not affect a movement of the movable structure. As a result, a performance deterioration of the movable structure can be prevented.

According to a second aspect of the invention, a cap attachment structure includes an adherend member, and a protective cap made of a material having a thermal plasticity. An outer peripheral edge part of the protective cap is attached to an adherend member so that the protective cap is fixed to the adherend member.

For forming the cap attachment structure according to the second aspect of the invention, at first, the protective cap is temporarily set on a surface of the adherend member. Then, a position of the protective cap is fine-adjusted so that an attachment position of the protective cap is set to the surface of the adherend member.

Next, the protective cap is heated so that the outer peripheral edge part is melted. After that, the outer peripheral edge part is cured by cooling, and the outer peripheral edge part is directly attached and fixed to the adherend member.

According to the second aspect of the invention, the adhesion layer described in the first aspect of the invention does not need to be formed. In addition, when the protective cap is attached to the adherend member, the protective cap is just need to be accurately positioned on the surface of the adherend member. As a result, according to the second aspect of the invention, in addition to prevent displacements of the protective cap and the adherend member, and to improve a precision of the attachment of the protective cap, the cap attachment structure can be provided at a low cost, as compared with the first aspect of the invention.

In the case that a movable structure is arranged on the surface of the adherend member, even if foreign materials such as dusts enter an attachment part of the movable structure on the adherend member, when the protective cap is bonded and fixed to the adherend member by the self thermo plasticity material, the foreign materials is bonded to the melted internal surface of the protective cap. The internal surface traps the foreign materials so that the foreign materials cannot drop off. Therefore, the possibility that the foreign materials having entered the attachment part of the movable structure on the adherend member adheres to the movable structure is reduced, and the foreign materials do not affect a movement of the movable structure. As a result, a performance deterioration of the movable structure can be prevented.

Furthermore, according to the second aspect of the invention, because the adhesion layer is not formed, there is no possibility that the adhesive for the adhesion layer adheres to the movable structure. Therefore, the attachment area provided on the surface of the adherend member, for attaching the outer peripheral edge part of the protective cap, is reduced. As a result, a compact cap attachment structure can be provided.

According to a third aspect of the invention, a cap attachment structure includes an adherend member, and a protective cap made of a material having a thermal plasticity. The protective cap is fixed to the adherend member by using the thermal plasticity of the protective cap.

According to the third aspect of the invention, the similar effects as the second aspect of the invention can be obtained.

According to a fourth aspect of the invention, a semiconductor device includes a sensor chip having a sensor structure made of a semiconductor, and a protective cap for covering the sensor structure, and an adhesive. The protective cap has a concave part at a position corresponding to that of the sensor structure and an outer peripheral edge part surrounding the concave part. The adhesive is applied to the outer peripheral edge part so that the protective cap is bonded and fixed to the sensor chip through the adhesive. The outer peripheral edge part of the concave part has a first end positioned on an inner rim surface, and a second end positioned on an outer rim surface. The first end protrudes toward the sensor chip more than the second end, and is adjacent to the sensor chip.

In a case that the first end on the inner rim surface protrudes toward the sensor chip more than the second end on the outer rim surface, when an exterior force is applied to the protective cap and the adhesive is protruded out by the force, the adhesive is leaked and protruded not inward but outward along a shape of the outer peripheral edge part. Therefore, the adhesive is prevented from entering the sensor structure, and the sensor structure can be prevented from sticking due to the adhesive.

According to a fifth aspect of the invention, a method of manufacturing a semiconductor device is provided. The semiconductor device includes a sensor chip, and a protective cap for covering a sensor structure of the sensor chip. The method includes: a step of preparing a protective base member, and forming an outer peripheral edge part into a taper or circular arc shape by carrying out an isotropic etching to the protective base member with a first mask material which covers predetermined positions where concave parts will be formed; a step of forming the concave parts by carrying out an etching to the protective base member with a second mask material having openings at the predetermined positions where the concave parts will be formed, after removing the first mask material; a step of preparing a semiconductor wafer in which the sensor structure is formed; a step of applying an adhesive to the outer peripheral edge part; a step of fixing the protective base member and the semiconductor wafer through the adhesive so that the sensor structure and the concave part correspond with each other; and a step of dividing the semiconductor wafer and the protective base member into chip units each of which has the sensor chip and the protective cap.

When an isotropic etching to the protective base member is carried out with a mask material covering the predetermined positions where the concave parts will be formed, the outer peripheral edge parts can be formed into taper or circular arc shapes.

Therefore, a first end on the inner rim surface protrudes toward the sensor chip more than a second end on the outer rim surface. As a result, when an exterior force is applied to the protective cap and the adhesive is protruded out by the force, the adhesive is leaked and protruded not inward but outward along the shape of the outer peripheral edge part. Thus, the adhesive is prevented from entering the sensor structure, and the sensor structure can be prevented from sticking due to the adhesive.

According to a sixth aspect of the invention, a method of manufacturing a semiconductor device is provided. The semiconductor device includes a sensor chip, and a protective cap for covering the sensor structure of the sensor chip. The method includes: a step of preparing a protective base member, and forming an outer peripheral edge parts into a stepped shape by removing an area having a predetermined space from a predetermined positions where concave parts will be formed; a step of forming the concave parts by carrying out an etching to the protective base member with a mask material having openings at the predetermined positions where the concave parts will be formed; a step of preparing a semiconductor wafer in which the sensor structure is formed; a step of applying an adhesive to the outer peripheral edge part; a step of fixing the protective base member and the semiconductor wafer through the adhesive so that the sensor structure and the concave part correspond with each other; and a step of dividing the semiconductor wafer and the protective base member into chip units each of which has the sensor chip and the protective cap.

According to the sixth aspect of the invention, the similar effect as that of the fifth aspect of the invention can be obtained.

### BRIEF DESCRIPTION OF THE DRAWINGS

Additional objects and advantages of the present invention will be more readily apparent from the following detailed description of preferred embodiments when taken together with the accompanying drawings. In the drawings:

FIG. 1A is a plan view showing a part of a micro device according to a first embodiment of the invention, and FIG. 1B is a cross-sectional view of the part of the micro device taken along line IB-IB in FIG. 1A;

FIGS. 2A to 2C are cross-sectional views showing an attachment process of a protective cap according to the first embodiment;

FIG. 3 is a cross-sectional view of a part of a micro device showing a modification of the first embodiment;

FIG. 4A is a plan view showing a part of a micro device according to a second embodiment of the invention, and FIG. 4B is a cross-sectional view of the part of the micro device taken along line IVB-IVB in FIG. 4A;

FIGS. 5A and 5B are cross-sectional views showing an attachment process of a protective cap according to the second embodiment;

FIG. 6 is a cross-sectional view of a part of a micro device showing a modification of the second embodiment;

FIG. 7 is a cross-sectional view of a semiconductor acceleration sensor according to a third embodiment of the invention;

FIG. 8 is an enlarged cross-sectional view showing a connection part between a sensor chip and a protective cap according to the third embodiment;

FIGS. 9A to 9F are cross-sectional views showing a manufacturing method of the semiconductor acceleration sensor in FIG. 7;

FIG. 10 is a plan view showing a plan configuration of a polyimide base member;

FIG. 11 is a plan view showing a plan configuration of a semiconductor wafer;

FIGS. 12A and 12B are cross-sectional views showing an attachment process of a protective cap to a sensor chip according to the third embodiment;

FIG. 13 is a perspective view showing a state where dicing-cut is curried out with a dicing blade;

FIG. 14 is an enlarged cross-sectional view showing a connection part between a sensor chip and a protective cap of a semiconductor acceleration sensor according to a fourth embodiment of the invention;

FIG. 15 is an enlarged cross-sectional view showing a connection part between a sensor chip and a protective cap of a semiconductor acceleration sensor according to a fifth embodiment of the invention; and

FIG. 16 is an enlarged cross-sectional view showing a connection part between a sensor chip and a protective cap of a semiconductor acceleration sensor according to the other embodiment of the invention.

### DETAILED DESCRIPTION OF THE PREFERRED EMBODIMENTS

### First Embodiment

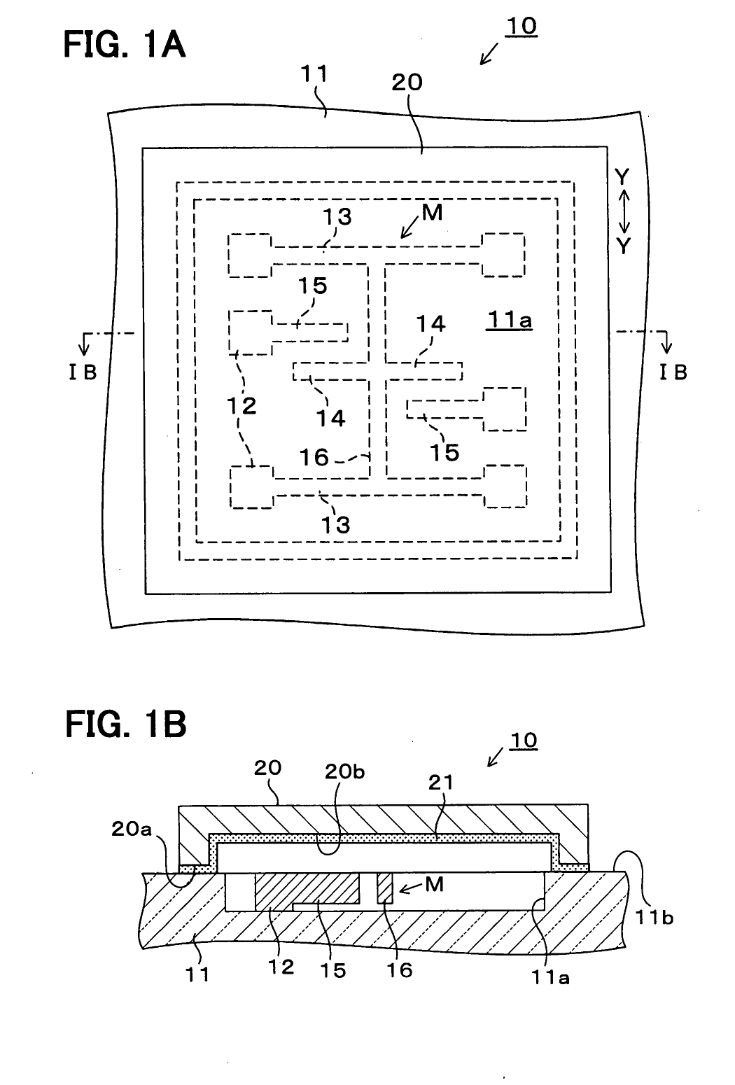

Referring to FIG. 1A and FIG. 1B, a micro device 10 according to a first embodiment of the invention includes a substrate (a wafer) 11, a movable structure M (e.g., bending springs 13, a movable electrode 14, and a spindle 16), a protective cap 20, and an adhesion layer 21.

On a surface 11b of the substrate 11 as an adherend member, a concave part 11a having an approximate rectangular parallelepiped shape is formed. As the substrate 11, a semiconductor substrate may be used, for example. For example, various type (e.g., polycrystalline, amorphous and mono crystal) silicon substrates may be used as the substrate 11. The movable structure M is positioned inside the concave part 11a. The protective cap 20 is attached to the surface 11b of the substrate 11 to cover the concave part 11a and the movable structure M.

The protective cap 20 has an approximate rectangular parallelepiped box shape in which the bottom face thereof is open, and the adhesion layer 21 is provided at an outer peripheral edge part 20a and an internal surface 20b. The surface 11b of the substrate 11 surrounding the concave part 11a is bonded to the outer peripheral edge part 20a of the protective cap 20 through the adhesive layer 21. The internal surface 20b of the protective cap 20 and the movable structure M are located to have a space therebetween so that the movement of the movable structure M can be accurately performed. That is, the movable structure M is stored in a space formed by the concave part 11a and the protective cap 20. As a material of the protective cap 20, a bulk material of various type (e.g., polycrystalline, amorphous and mono crystal) silicons may be used.

The movable structure M includes components such as bending springs 13, a movable electrode 14, and a spindle 16. The movable structure M is fabricated with a MEMS technique. The components such as anchor blocks 12, the bending springs 13, the movable electrode 14, fixed electrodes 15 and the spindle 16 are formed in the substrate 11.

The movable structure M is connected tightly to the substrate 11 by the anchor blocks 12. The bending springs 13 are fixed to the anchor blocks 12, and the bending springs 13 hold the spindle 16. That is, the spindle 16 is held by each of the anchor blocks 12 through each of the bending springs 13. The movable electrode 14 is fixed to the spindle 16. The movable electrode 14 is located perpendicularly to the long and thin spindle 16. The fixed electrodes 15 are located opposite to the movable electrode 14, and outer end parts of the fixed electrodes 15 are connected tightly to the substrate 11 by the anchor blocks 12.

The movable structure M functions as an acceleration sensor, and detects an acceleration applied in a direction of a measuring axis shown by the arrow Y-Y in FIG. 1A. When the acceleration is applied in the direction of the measuring axis, a force in accordance with the acceleration acts to the spindle 16. Because the spindle 16, the bending springs 13, and the movable electrode 14 are not directly connected to the substrate 11, the bending springs 13 are bent and deformed in accordance with the force acting to the spindle 16, and the movable electrode 14 displaces in the direction of the measuring axis in accordance with the deformation of the bending springs 13. Then, distances between the movable electrode 14 and each of the fixed electrodes 15 are changed, and electrical capacities between the electrodes 14 and 15 are changed. Therefore, by detecting the change of the electrical capacities between the electrodes 14 and 15, a displacement of the spindle 16 in accordance with the change of the electrical capacities can be detected. As a result, the acceleration in the direction of the measuring axis line proportional to the displacement of the spindle 16 can be detected.

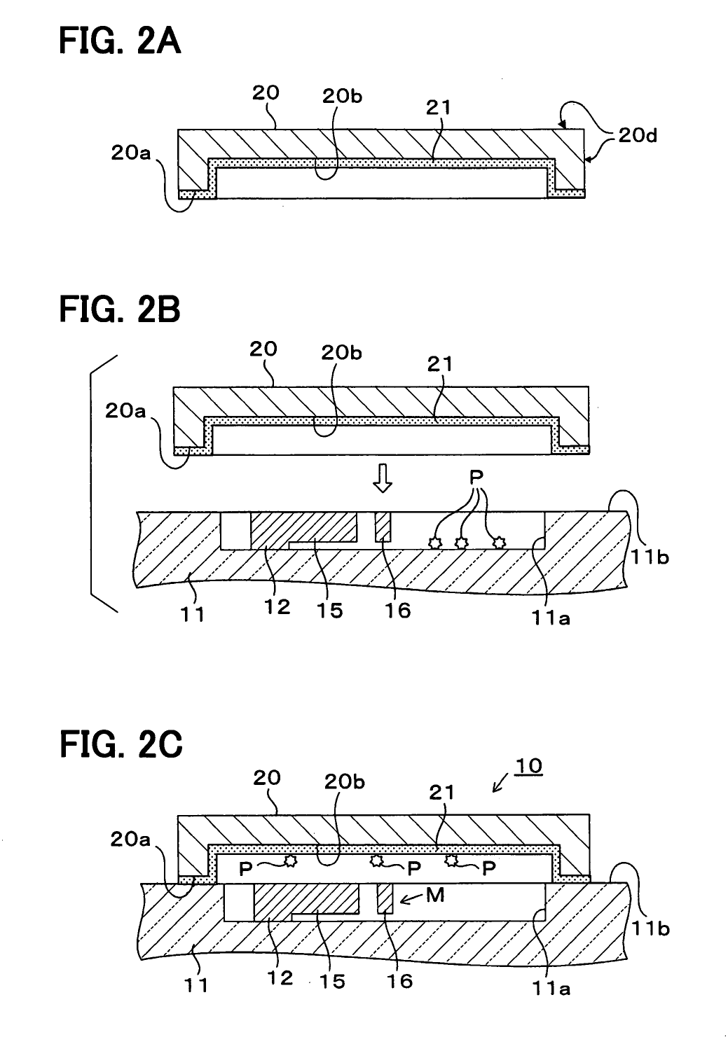

FIGS. 2A to 2C are cross-sectional views showing an attachment process of the protective cap according to the first embodiment. At first, the adhesion layer 21 is provided at the outer peripheral edge part 20a and the internal surface 20b of the protective cap 20 as shown in FIG. 2A. For example, the adhesive for forming the adhesion layer 21 may be provided on an external surface 20d of the protective cap 20.

Furthermore, the adhesion layer 21 may be formed by the following methods. For example, by using a spray, the adhesive for forming the adhesion layer 21 may be sprayed on the outer peripheral edge part 20a and the internal surface 20b of the protective cap 20. Alternatively, by using a printing technique, the adhesive may be transferred to the outer peripheral edge part 20a and the internal surface 20b of the protective cap 20 so as to form the adhesion layer 21. Alternatively, by pressing and rolling a roller to which the adhesive is bonded on the outer peripheral edge part 20a and the internal surface 20b of the protective cap 20, the adhesion layer 21 may be formed. Alternatively, the adhesion layer 21 may be formed by putting the protective cap 20 in a container which houses the adhesive, soaking the protective cap 20 in the adhesive, and pulling the protective cap 20 from the container.

Then, an attachment part of the protective cap 20 is positioned to the surface 11b of the substrate 11 as shown in FIG. 2B, and the outer peripheral edge part 20a of the protective cap 20 is pressed to the surface 11b of the substrate 11 so that the outer peripheral edge part 20a is bonded and fixed to the substrate 11 through the adhesion layer 21 as shown in FIG. 2C.

According to the first embodiment, the following effects can be obtained.

[1-1] When the adhesion layer 21 is formed on the outer peripheral edge part 20a and the internal surface 20b, a position of the adhesive for forming the adhesion layer 21 is not required to be accurately set beforehand. Therefore, when the protective cap 20 is attached to the substrate 11, a position setting is required only for attaching the protective cap 20 onto the surface 11b of the substrate 11. That is, in the first embodiment, the position setting is required for the one time.

Therefore, according to the first embodiment, a number of the position setting can be reduced. As a result, according to the first embodiment, in addition to prevent displacements of the protective cap 20 and the substrate 11, and to improve a precision of the attachment of the protective cap 20, a production cost of the micro device 10 can be reduced.

[1-2] As a material of the adhesive for forming the adhesion layer 21, an adhesive having at least one property selected from the group including a thermo plasticity, a thermosetting, a photo-curing, a chemical reaction-curing, and a solvent evaporation-curing may be used. The adhesive may be suitably selected from experiments by cut-and-try.

Thermoplastic materials include glass materials, rubber materials, e.g., a natural rubber and a synthetic rubber, various plastic materials including a thermoplastic resin material, and various wax materials. Thermosetting materials include various synthetic rubber materials, and various plastic materials including a thermosetting resin material. Photo-curing materials include various plastic materials including a photo-curing resin material.

Chemical reaction-curing materials and solvent evaporation-curing materials include various synthetic rubber materials and various plastic materials. Specifically, chemical reaction-curing materials include a cyanoacrylate material cured by moisture on a surface of the adherend as catalysis, and a two-component epoxy resin material.

The synthetic rubber materials include a diene-based material, a polysulfide-based material, an olefine-based material, an organosilicon compound-based material, a fluorine compound-based material, an urethane-based material, and vinyl-based material.

The plastic materials include porimeric types (e.g., a carbon hydride-based material, an acryl-based material, a vinyl acetate-based material, and a halogen-containing-based material), condensed types (e.g., a polyimide-based material, a polyamide-based material, a polyamide-imide-based material, a polyether-based material, an amino-based material, a polyester-based material, a polyurethane-based material, a phenol-based material, and an epoxy-based material), and semi-synthetic polymer types (e.g., a cellulose-based material, and a protein-based material).

Furthermore, by adding a photosensitive function to the adhesive having at least one property, selected from the group including a thermo plasticity, a thermosetting, a photo-curing, a chemical reaction-curing, and a solvent evaporation-curing, the adhesion layer 21 having a photosensitivity can be formed. When the adhesion layer 21 has the photosensitivity, a shape of the adhesion layer 21 can be controlled by an exposure and development process, so the more effective shape can be provided.

[1-3] When the thermoplastic material is used as the adhesive for forming the adhesion layer 21, the following attachment process makes easy the position setting of the protective cap 20 and enhances the effects of the above described [1-1].

The adhesive is attached to the outer peripheral edge part 20a and the internal surface 20b of the protective cap 20, and the adhesive is cured by cooling (temporary curing) to form the adhesion layer 21 (step 1). The position of the protective cap 20 is temporarily set on the surface 11b of the substrate 11 (step 2).

By fine adjusting a setting position of the protective cap 20, the attachment position of the protective cap 20 is accurately set to the surface 11b of the substrate 11 (step 3). After the adhesion layer 21 is heated so that the adhesive is melted, the adhesive is cured by cooling (permanent curing), and the outer peripheral edge part 20a of the protective cap 20 is bonded and fixed to the substrate 11 through the adhesion layer 21 (step 4). In the step 4, the method of heating the adhesion layer 21 includes a process in which the micro device 10 is taken in a container heated by an electric heater, and a process in which the micro device 10 is applied with an infrared light from an infrared lamp.

[1-4] In the case that the thermoplastic material is used as the adhesive for forming the adhesion layer 21, when the outer peripheral edge part 20a of the protective cap 20 is pressed on the surface 11b of the substrate 11, there is no possibility that the adhesive protrudes and flows out from a contact portion between the outer peripheral edge part 20a and the surface 11b, and that the adhesive adheres on the movable structure M. Therefore, an attachment area, to be attached with the outer peripheral edge part 20a, can be provided on the surface 11b of the substrate 11 to be smaller.

As a result, a surface area of substrate 11 becomes small in accordance with a reduction of the attachment area, and the micro device 10 can be miniaturized. That is, in the first embodiment, by using the thermoplastic material as the adhesive for forming the adhesion layer 21, a compact attachment structure of the protective cap 20 is provided.

[1-5] As shown in FIG. 2B, in the case that foreign materials P such as dusts enter in the concave part 11a of the substrate 11, when the protective cap 20 is bonded and fixed to the substrate 11 through the adhesion layer 21, the foreign materials P is bonded to the adhesion layer 21 and the adhesion layer 21 holds the foreign materials P so that the foreign materials P cannot drop off, thereby the foreign materials P are trapped by the adhesion layer 21. Therefore, the possibility that the foreign materials P having entered in the concave part 11a adheres to the movable structure M is reduced, and the foreign materials P do not affect a movement of the movable structure M. As a result, a performance deterioration of the movable structure M can be prevented.

[1-6] When the adhesive of the adhesion layer 21 formed on the internal surface 20b of the protective cap 20 does not cure and have an adhesive function even after the protective cap 20 is bonded and fixed to the substrate 11, even if dusts are generated from the movable structure M during an operation, the foreign materials P including the dusts are trapped by the adhesion layer 21.

Therefore, the possibility that the foreign materials P generated from the movable structure M during the operation adhere to the movable structure M is reduced, and the foreign materials P do not affect the movement of the movable structure M. As a result, a performance deterioration of the movable structure can be prevented.

Because the internal surface 20b of the protective cap 20 and the movable structure M are located to have the space therebetween, and the adhesion layer 21 does not touch the movable structure M, the movement of the movable structure M is not restricted even if the adhesive of the adhesion layer 21 provided on the internal surface 20b does not cure.

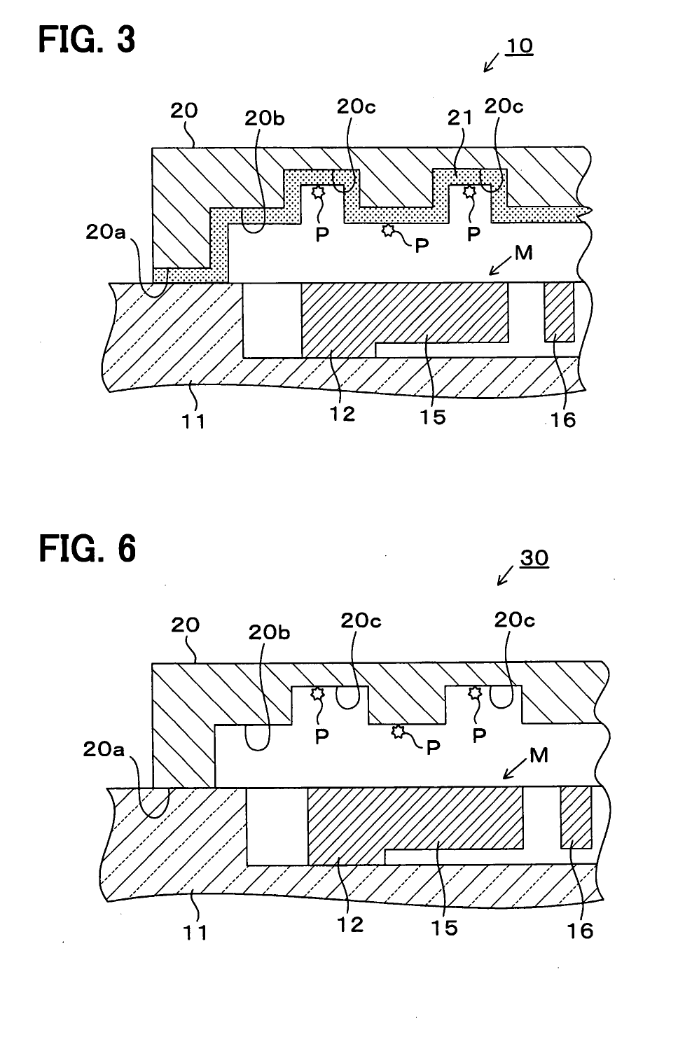

For keeping the adhesive function of the adhesion layer 21 provided on the internal surface 20b of the protective cap 20, for example, a photo-curing adhesive may be used. That is, when the protective cap 20 is attached to the substrate 11 through the adhesion layer 21, only the adhesive applied on the outer peripheral edge part 20a of the protective cap 20 is irradiated with a light (e.g., a visible light and an ultraviolet light) and cured, and the adhesive applied on the internal surface 20b of the protective cap 20 is not irradiated with the light and is not cured.

[1-7] As shown in FIG. 3, in a micro device 10 according a modification of the first embodiment, a plurality of concave parts 20c are formed in the internal surface 20b of the protective cap 20.

By providing the concave parts 20c, the surface area of the internal surface 20b increases, and the surface area of the adhesion layer 21 provided on the internal surface 20b also increases. Therefore, the foreign materials P becomes easy to trapped by the adhesion layer 21. The number, the plane shapes, and the cross-sectional shapes of the concave parts 20c may be suitably set experimentally by cut-and-try so that the above described effects are certainly obtained.

[1-8] When the adhesion layer 21 has an electric conductivity, even if the movable structure M generates a static electricity during the attachment of the protective cap and the operating of the movable structure M, the static electricity is discharged through the adhesion layer 21. In addition, when the adhesion layer 21 has the electric conductivity, even if the static electricity is generated in a vicinity of the micro device 10, the adhesion layer 21 works as an electrostatic shield. Therefore, the static electricity does not affect the movable structure M.

As a result, the movable structure M is not affected by the static electricity, and the movable structure M can be moved freely, so the performance deterioration of the movable structure can be prevented. For giving the electric conductivity to the adhesion layer 21, for example, a conducting material as the adhesive for forming the adhesion layer 21, and a sol material in which fine powders of a conductive material is dispersed in the adhesive may be used.

[1-9] When transparent materials are used for the protective cap 20 and the adhesion layer 21, an existence of the foreign material P and an operation of the movable structure M are visible from outside of the protective cap 20. Therefore, an operation check of the micro device 10 becomes easy.

### Second Embodiment

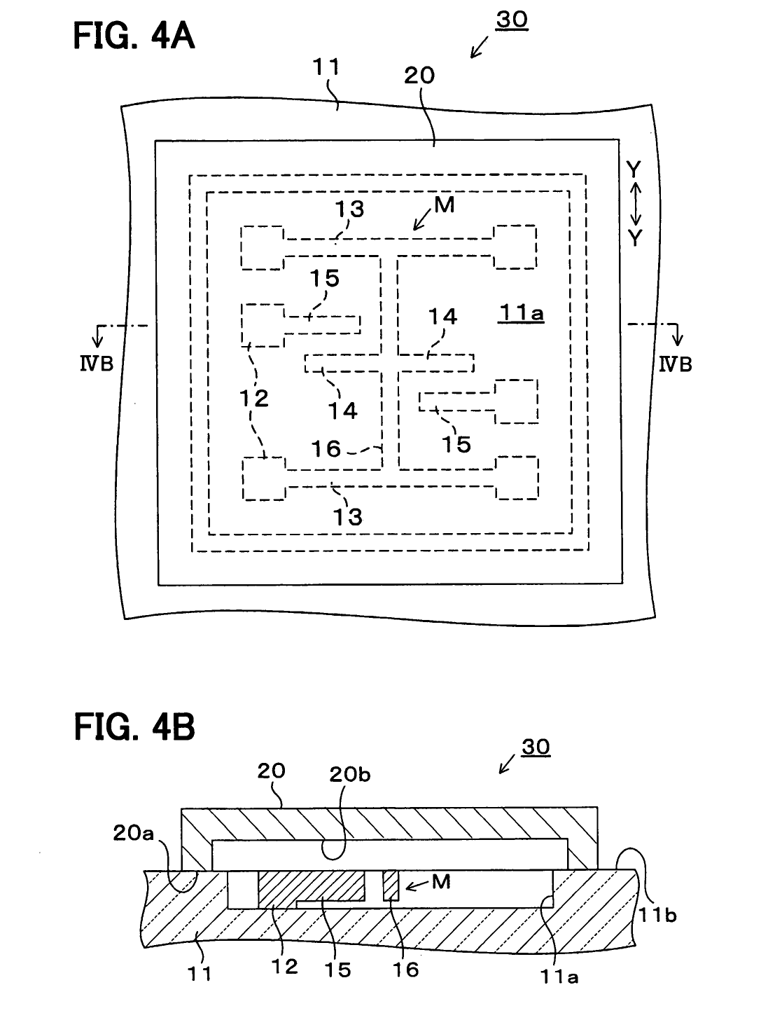

Referring to FIG. 4A and FIG. 4B, a micro device 30 according to a second embodiment of the invention includes the substrate 11, the movable structure M (e.g., anchor blocks 12, bending springs 13, the movable electrode 14, fixed electrodes 15, and the spindle 16), and the protective cap 20.

The micro device 30 according to the second embodiment is different from the micro device 10 according to the first embodiment in that the micro device 30 does not include the adhesion layer 21 of the micro device 10, and that the protective cap 20 of the micro device 30 is made of a thermoplastic material.

The thermoplastic material for the protective cap 20 of the micro device 30 is the same with the thermoplastic material for the adhesion layer 21 of the micro device 10.

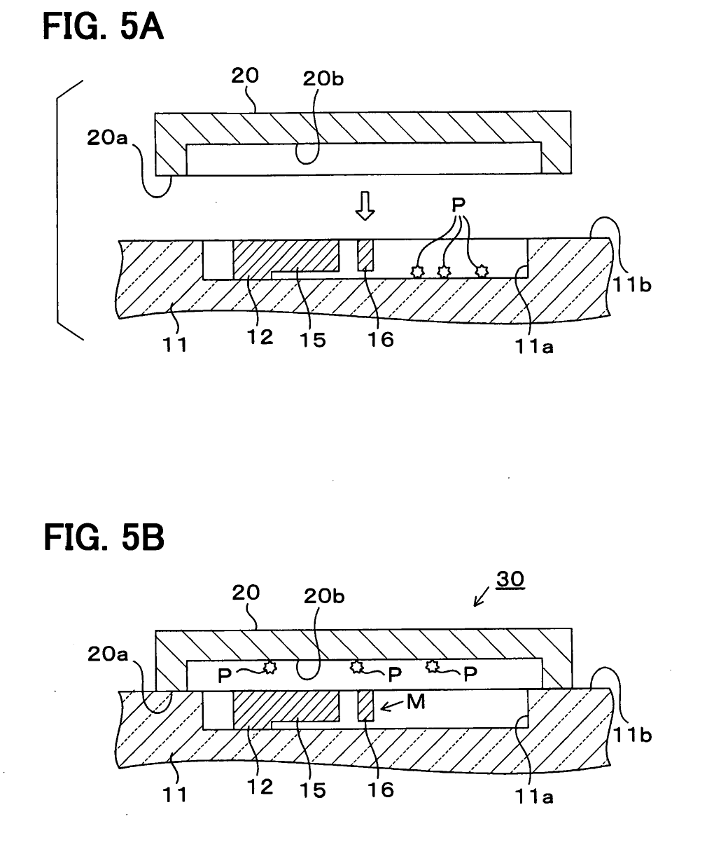

FIG. 5A and FIG. 5B are cross-sectional views showing an attachment process of the protective cap 20 according to the second embodiment. As shown in FIG. 5A, at first, the protective cap 20 is temporarily set on the surface 11 b of the substrate 11. Then, a setting position of the protective cap 20 is fine-adjusted so that an attachment position of the protective cap 20 is accurately set on the surface 11b of the substrate 11.

Next, as shown in FIG. 5B, the protective cap 20 is heated so that the outer peripheral edge part 20a is melted. After that, the outer peripheral edge part 20a is cured by cooling, and the outer peripheral edge part 20a of the protective cap 20 is directly bonded and fixed to the substrate 11. A method of heating the protective cap 20 includes a process in which the micro device 30 is taken in the container heated by the electric heater, and a process in which the micro device 30 is irradiated with the infrared light from the infrared lamp.

According to the second embodiment, the following effects can be obtained.

[2-1] In the second embodiment, the adhesion layer 21 described in the first embodiment does not need to be formed. Additionally, when the protective cap 20 is attached to the substrate 11, the protective cap 20 is just needed to be accurately positioned on the surface 11b of the substrate 11. Therefore, according to the second embodiment, the position setting of the protective cap 20 relative to the substrate 11 becomes easy similarly to the above described [1-3]. In addition, according to the second embodiment, the protective cap 20 can be bonded to the substrate 11 by the self thermo plasticity material, so the process in the first embodiment that the adhesion layer 21 is formed on the protective cap 20 and the protective cap 20 is attached to the substrate 11 though the adhesion layer 21 does not need. Therefore, numbers of process accompanied with forming and attaching of the adhesion layer 21 are reduced, and a production cost of the micro device 30 is reduced, as compared with the first embodiment.

[2-2] Because the adhesion layer 21 is not formed, there is no possibility that the adhesive for the adhesion layer 21 adheres to the movable structure. Therefore, the attachment area provided on the surface 11b of the substrate 11, for attaching the outer peripheral edge part 20a of the protective cap 20, is reduced. As a result, according to the second embodiment, the same effect as above described [1-4] can be obtained.

[2-3] Even if foreign materials P such as dusts enter in the concave part 11a of the substrate 11 (as shown in FIG. 5A), when the protective cap 20 is bonded and fixed to the substrate 11, the foreign materials P is bonded to the melted internal surface 20b of the protective cap 20 (as shown in FIG. 5B). The internal surface 20b traps the foreign materials P so that the foreign materials P cannot drop off. Therefore, according to the second embodiment, the same effect as above described [1-5] can be obtained.

[2-4] FIG. 6 is a cross-sectional view showing a part of the micro device 30 according to a modification of the second embodiment. FIG. 6 is different from FIG. 4B in that a plurality of concave parts 20c are formed on the internal surface 20b of the protective cap 20 in FIG. 6. That is, uneven portion with the concave parts 20c and protrusion parts are provided on the internal surface 20b of the protective cap 20.

According to the modification shown in FIG. 6, by providing the concave parts 20c, the surface area of the internal surface 20b increases. Therefore, the foreign materials P become easy to trapped by the internal surface 20b, and the above-described effect [2-3] is enhanced.

[2-5] When the protective cap 20 has an electric conductivity, even if the movable structure M generates a static electricity during the attachment of the protective cap 20 and the operating of the movable structure M, the static electricity is discharged through the protective cap 20. In addition, when the protective cap has the electric conductivity, even if the static electricity is generated in a vicinity of the micro device 10, the protective cap 20 works as an electrostatic shield. Therefore, the static electricity does not affect the movable structure M.

As a result, the movement of the movable structure M is not affected by the static electricity, and the movable structure M can be moved freely, so the performance deterioration of the movable structure M can be prevented. For giving the electric conductivity to the protective cap 20, for example, the protective cap 20 may be made of a conducting material, or a material dispersed with fine powders of a conducting material.

[2-6] When a transparent material is used for the protective cap 20, an existence of the foreign materials P and an operation of the movable structure M are visible from outside of the protective cap 20. Therefore, an operation check of the micro device 30 becomes easy.

### Third Embodiment

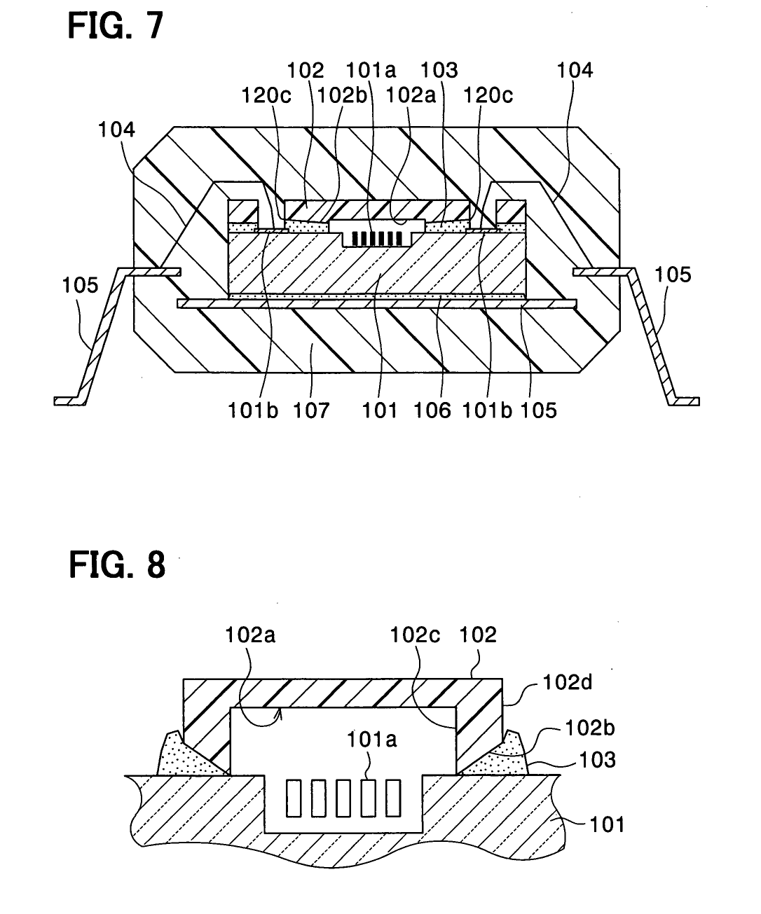

FIG. 7 is a cross-sectional view of a semiconductor acceleration sensor according to the third embodiment of the invention. In the semiconductor acceleration sensor, a sensor chip 101 is inserted in a molded resin 107.

The sensor chip 101 may have a configuration similar with a sensor chip described in JP-A-1997-211022. In the sensor chip 101, a sensor structure 101a formed on a silicon wafer includes a beam structure having movable electrodes displaced in accordance with acceleration, and fixed electrodes located facing to the movable electrodes. The sensor chip 101 outputs a detecting signal in accordance with acceleration based on displacements between the movable electrodes and the fixed electrodes.

On the surface of the sensor chip 101, a plurality of pads 101b are provided so that the movable electrodes and fixed electrodes are connected electrically with outside. Through the pads 101b, a voltage is applied to the sensor structure 101a, and the detecting signal is output.

A protective cap 102 for protecting the sensor structure 101a is provided on the surface of the sensor chip 101. The protective cap 102 is composed of a heat-resisting resin sheet, and is bonded to the sensor chip 101 by a heat resisting adhesive 103. The protective cap 102 and the adhesive 103 have heat resistances higher than a heat treatment temperature (e.g., 150° C. to 180° C.) in a process including a wire bonding and a resin molding. Specifically, as the heat-resisting resin sheet, a polyimide base member having a heat resistance of approximately 400° C. can be used. As the adhesive 103, a silicone adhesive having a heat resistance of approximately 230° C. can be used.

As shown in FIG. 8, the protective cap 102 has a concave part 102a and an outer peripheral edge part 102b surrounding the concave part 102a. The adhesive 103 is applied to the outer peripheral edge part 102b.

The outer peripheral edge part 102b has a taper shape inclining against a surface of the sensor chip 101. Specifically, a first end positioned on an inner rim surface 102c of the concave part 102a (i.e., an inner edge position of the protective cap 102) protrudes toward the sensor chip 101 more than a second end positioned on an outer rim surface 102d of the concave cap 102a (i.e., an outer edge position of the protective cap 102). Therefore, the first end on the inner rim surface 102c is adjacent (touches or nearly touches) to the sensor chip 101, and the second end on the outer rim surface 102d is spaced from the sensor chip 101. The adhesive 103 is filled between the taper-shaped outer peripheral edge part 102b and the sensor chip 101, and the protective cap 102 is preferably connected with the sensor chip 101.

As shown in FIG. 7, the protective cap 102 has contact holes 120c as aperture parts to expose the pads 101b provided on the surface of the sensor chip 101 when the resin 107 is not molded. Bonding wires 104 are connected to the pads 101b through the contact holes 120c, and the pads 101b are connected electrically with lead frames 105 through the bonding wires 104. The sensor chip 101 is fixed to the lead frame 105 by a silver paste 106, and the whole is surrounded with the resin 107.

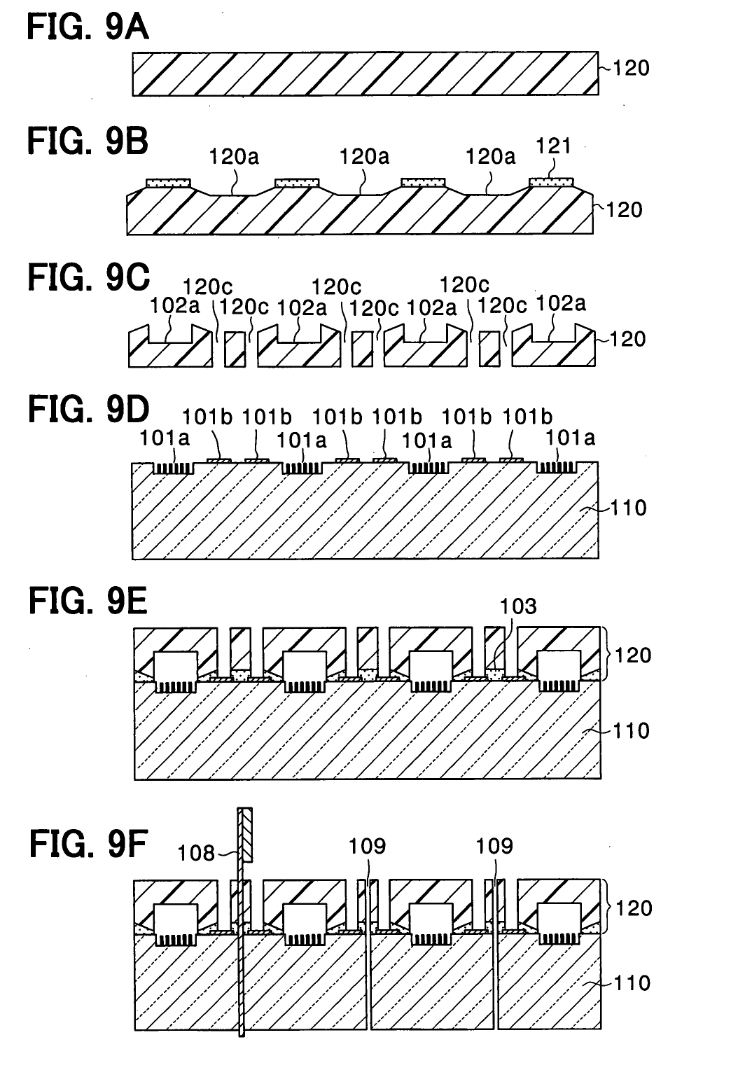

A manufacturing method of the semiconductor acceleration sensor in FIG. 7 is described below with referring to FIGS. 9A to 9F.

### [Step Shown in FIG. 9A]

A polyimide base member 120 for forming the protective cap 102 is prepared. A preferred thickness of the polyimide base member 120 is 50 μm to 150 μm for making a dicing cut easy in a post-process.

### [Step Shown in FIG. 9B]

A mask material 121 (mask layer) is provided on the polyimide base member 120. After opening the mask material 121 at an area except for a portion where the concave parts 102a of the protective caps 102 will be formed, an isotropic wet etching is carried out to the poryimide base member 120 with the mask material 121. As a result, recess parts 120a are formed at opening portions of the mask material 121 on the polyimide base member 120. Because the isotropic wet etching is carried out, portions located at open-end parts of mask material 121 in the recess parts 120a, that is, the portions corresponding to the outer peripheral edge parts 102b of the concave parts 102a become taper shapes.

### [Step Shown in FIG. 9C]

After removing the mask material 121 in FIG. 9B, new mask material is provided on the polyimide base member 120 (not shown). The mask material is opened at the portions where the concave parts 102a will be formed. Then, an anisotropic wet etching is carried out to the polyimide base member 120 with the new mask material. As a result, the concave parts 102a are formed in the polyimide base member 120. The concave parts 102a are formed so that when the polyimide base member 120 for forming the protective cap 102 is attached to the sensor chip 101, the sensor chip 101a does not contact the polyimide base member 120.

In the third embodiment, a processing of the concave parts 102a is carried out by the anisotropic wet etching. However, an excimer laser is also suitable. When the excimer laser is used, the depth of the concave parts 102a is controlled by a number of shot. For improving a throughput of the processing, it is prefer to use a mask for slightly broadening a laser light, to disperse the laser light into a few lines, and to increase a number of laser oscillator.

Next, in the polyimide base member 120, the contact holes 120c are opened at positions corresponding to the positions of the sensor chip 101 where the pads 101b are provided. The processing of the contact holes 120c may be also curried out by the excimer laser and a punching. An aperture size of the contact holes 120c may be smaller or bigger than that of the pads 101b as long as the wire bonding is possible through the apertures. In addition, the concave parts 102a and the contact holes 120c may be formed in advance of each other.

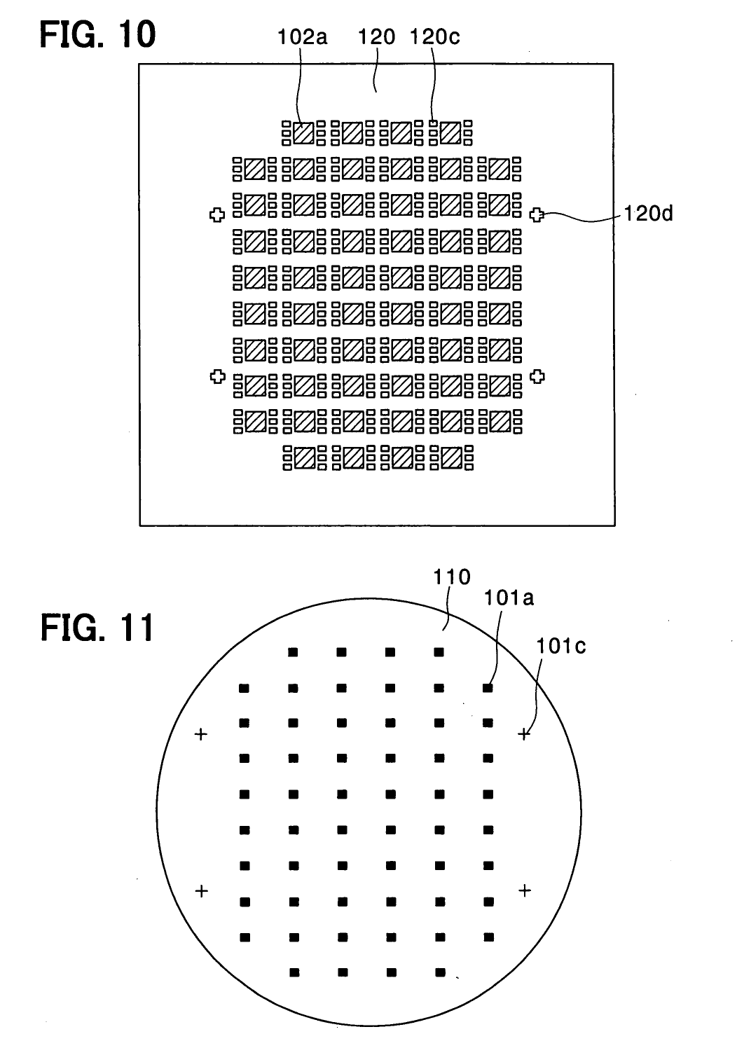

As shown in FIG. 10, the concave parts 102a and the contact holes 120c are formed into an array arrangement in the polyimide base member 120. The arrangement is corresponding to positions of each of the sensor chip 101 formed on a semiconductor wafer 110. Alignment keys 120d (positioning keys) are provided at outside of the concave parts 102a and the contact holes 120c on the polyimide base member for an alignment against the semiconductor wafer 110. The alignment key 120d are formed by the excimer laser at the same time when the contact holes 120c are formed, for example.

### [Step shown in FIG. 9D]

The semiconductor wafer 110 having the sensor chip 101a and the aluminum pads 101b formed thereon is prepared. Manufacturing methods of the sensor chip 101a and the pads 101b generally well known in the art may be used, and are not described here.

As shown in FIG. 11, on the semiconductor wafer, the sensor structures 101a are formed at positions corresponding to that of each of the sensor chips 101, and alignment keys 101c are formed with aluminum for an alignment (position setting) against the polyimide base member 120. The pads 101b are not shown in FIG. 11.

### [Step Shown in FIG. 9E]

The adhesive 103 is applied to a portion on the surface of the polyimide base material 120 except for the concave part 102a. Then, the polyimide base material 120 is bonded to the semiconductor wafer 110 having the sensor chip 101 through the adhesive 103.

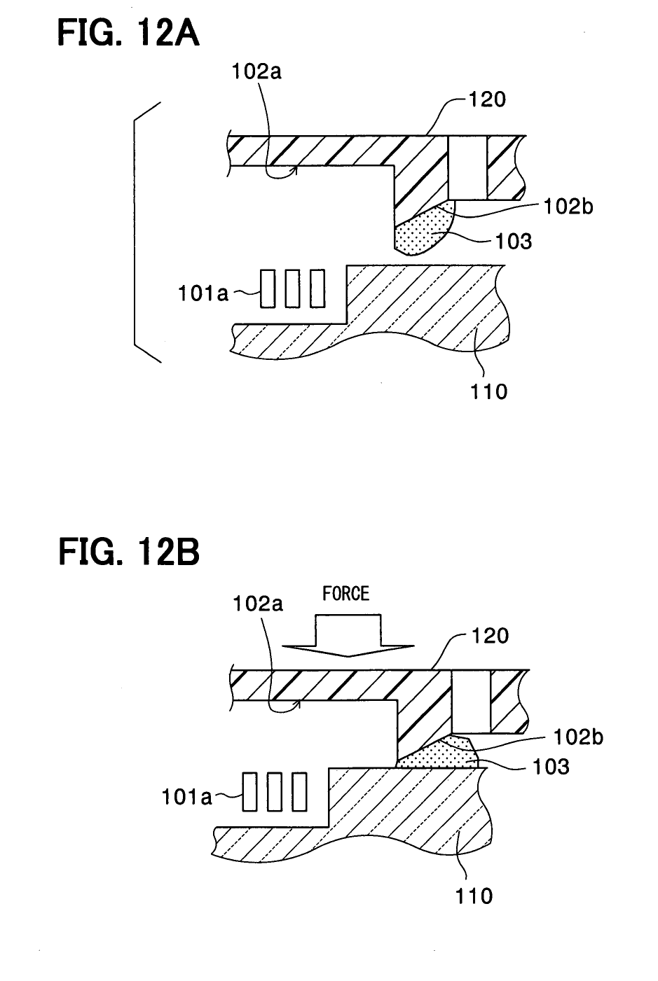

Specifically, as shown in FIG. 12A, the adhesive 103 is applied to the portion on the end surface of the polyimide base material 120 except for the concave parts 102a, that is, a portion around the outer peripheral edge parts 102b by a method such as a printing and a dispense. Then, the polyimide base material 120 is bonded to the semiconductor wafer through the adhesive 103 so that the alignment keys 120d of the polyimide base material 120 and the alignment keys 101c of the semiconductor wafer 110 correspond with each other, and each of the sensor structure 101a is housed in each of the concave part 102a of the polyimide base material 120.

Furthermore, as shown by the arrow in FIG. 12B, an exterior force (pressing) is applied to the polyimide base material 120 for forming the protective cap 102, and the adhesive 103 is protruded out by the force. At the time, the adhesive 103 is protruded out in a direction which the adhesive 103 is easy to get away. Because the outer peripheral edge part 102b has the taper shape, the adhesive 103 is leaked and protruded not inward but outward along an inclination of the taper shape. Therefore, the adhesive 103 is protruded outward of the concave part 102a, and is prevented from entering the sensor structure 101a. As a result, the sensor structure 101a is prevented from sticking due to the adhesive 103.

### [Step Shown in FIG. 9F]

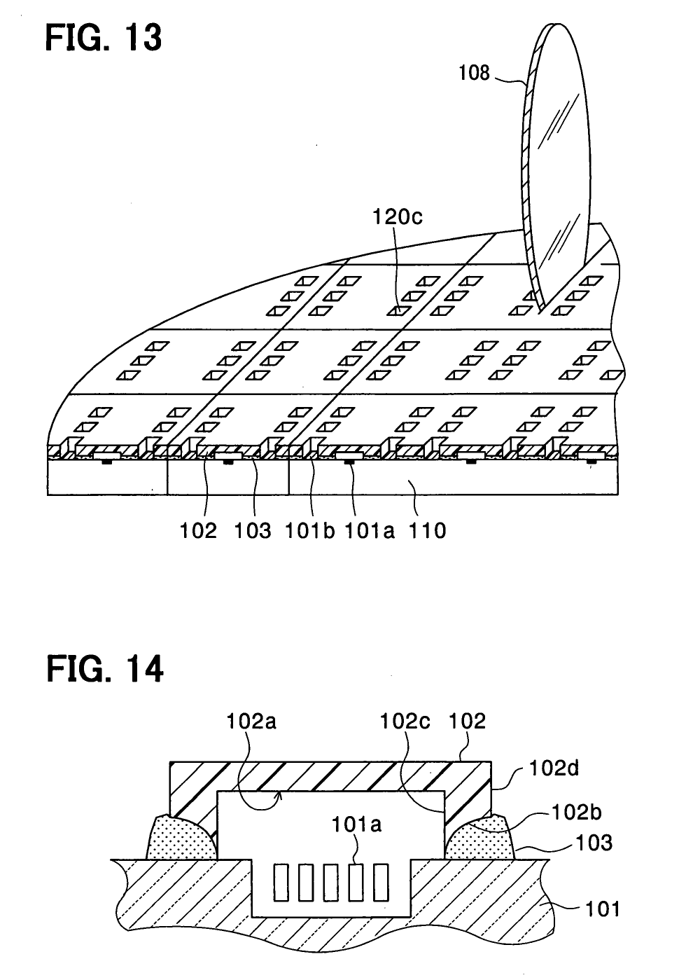

The dicing cut is curried out along a scribing pattern formed on the semiconductor wafer 110 referring to the pads 101b exposed through the contact holes 120c. FIG. 13 shows a state where dicing-cut is curried out with a dicing blade 108. By the dicing cut, the polyimide base member 120 and the semiconductor wafer 110 are divided into chip units, and the protective caps 102 and the sensor chips 101 are formed.

Then, the sensor chip 101 formed into the chip unit is fixed onto the lead frame 105 by the silver paste 106, the pads 101b and the lead frames 105 are bonded by the bonding wires 104, and the whole is inserted in the molded resin 107 as shown in FIG. 7. As a result, the semiconductor acceleration sensor is completed.

In the above described manufacturing method, a heat treatment in which the sensor chip 101 is fixed to the lead frame 105 by the silver paste 106, a heat treatment in which the pads 101b and the lead frames 105 are bonded by the bonding wires 104, and a heat treatment during the resin molding are needed. However, because the heat resistance temperature of the polyimide base member 120 is approximately 400° C., the semiconductor acceleration sensor can be formed with keeping a shape of the polyimide base member 120.

As described above, in the semiconductor acceleration sensor according to the third embodiment, the outer peripheral edge part 102b of the protective cap 102 is formed into the taper shape. Therefore, when the exterior force is applied to the polyimide base member 120 and the adhesive 103 is protruded out by the force, the adhesive 103 is leaked and protruded not inward but outward along the inclination of the taper shape. As a result, the adhesive 103 is prevented from entering the sensor structure 101a, and the sensor structure 101a can be prevented form sticking due to the adhesive 103.

### Fourth Embodiment

FIG. 14 shows a connection part between a sensor chip 101 and a protective cap 102 of a semiconductor acceleration sensor according to a fourth embodiment of the invention. The semiconductor acceleration sensor according to the fourth embodiment has a basically same structure as that of the third embodiment except for a structure of the protective cap 102. Therefore, a different portion of the protective cap 102 is mainly described here.

As shown in FIG. 14, the protective cap 102 has a concave part 102a and an outer peripheral edge part 102b surrounding the concave part 102a. The adhesive 103 is applied to the outer peripheral edge part 102b.

The outer peripheral edge part 102b is formed into a circular arc shape (R shape) in cross section. Specifically, a first end positioned on an inner rim surface 102c of the concave part 102a (i.e., an inner edge position of protective cap 102) protrudes toward the sensor chip 101 more than a second end positioned on an outer rim surface 102d of the concave part 102a (i.e., an outer edge position of the protective cap 102). Therefore, the first end on the inner rim surface 102c is adjacent to the sensor chip 101, and the second end on the outer rim surface 102d is spaced from the sensor chip 101. The outer peripheral edge part 102b is formed into a circular edge shape in cross section which connects the first end and the second end. The adhesive 103 is filled between the circular-arc shaped outer peripheral edge part 102b and the sensor chip 101, and the protective cap 102 is preferably connected with the sensor chip 101.

Also in the structure of the protective cap 102 according to the fourth embodiment, when the exterior force is applied to the polyimide base member 120 and the adhesive 103 is protruded out by the force, the adhesive 103 is leaked and protruded not inward but outward along the inclination of the circular arc shape of the outer peripheral edge part 102b. Therefore, the adhesive 103 is prevented from entering the sensor structure 101a, and the sensor structure 101a can be prevented from sticking due to the adhesive 103.

Because the above described circular arc shape can be obtained by selecting an etchant for the isotropic wet etching in the step shown in FIG. 9B described in the third embodiment, the semiconductor acceleration sensor having the structure according to the fourth embodiment can be obtained by the similar manufacturing method as that of the third embodiment, basically.

### Fifth Embodiment

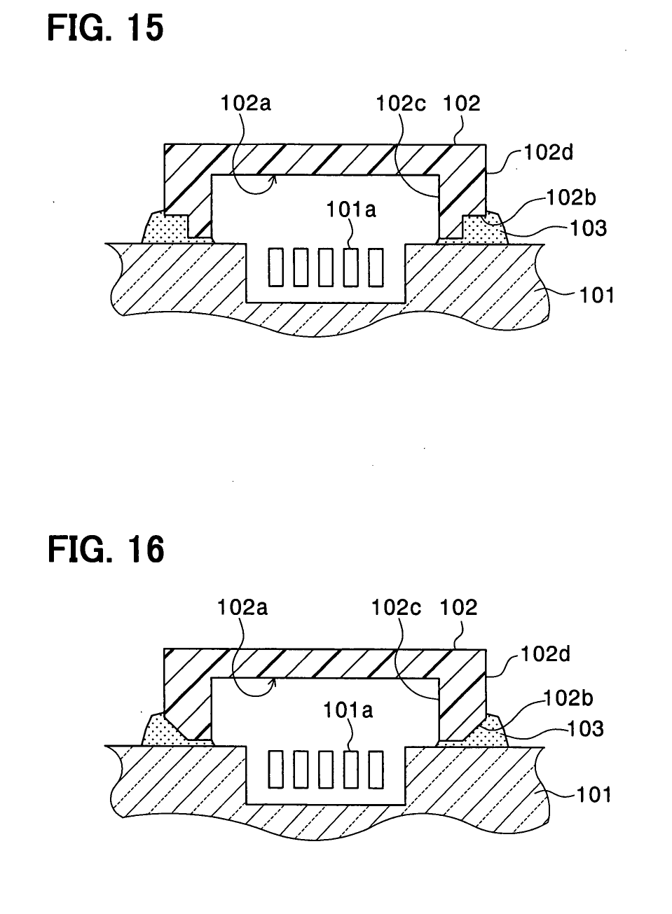

FIG. 15 shows a connection part between a sensor chip 101 and a protective cap 102 of a semiconductor acceleration sensor according to the fifth embodiment of the invention. The semiconductor acceleration sensor according to the fifth embodiment has the basically same structure as that of the third embodiment except for a structure of the protective cap 102. Therefore, a different portion of the protective cap 102 is mainly described here.

As shown in FIG. 14, the protective cap 102 has a concave part 102a and an outer peripheral edge part 102b surrounding the concave part 102a. The adhesive 103 is applied to the outer peripheral edge part 102b to be bonded to the sensor chip 101.

The outer peripheral edge part 102b is formed into a stepped shape. Specifically, a first end positioned on an inner rim surface 102c of the concave part 102a (i.e., an inner edge position of protective cap 102) protrudes toward the sensor chip 101 more than a second end positioned on an outer rim surface 102d of the concave part 102a (i.e., an outer edge position of the protective cap 102). Therefore, the first end on the inner rim surface 102c is adjacent to the sensor chip 101, and the second end on the outer rim surface 102d is spaced from the sensor chip 101. The adhesive 103 is filled between the stepped shaped outer peripheral edge part 102b and the sensor chip 101, and the protective cap 102 is preferably connected with the sensor chip 101.

Also in the structure of the protective cap 102 according to the fifth embodiment, when the force is applied to the protective cap 102 and the adhesive 103 is protruded out by the force, the adhesive 103 is leaked and protruded not inward but outward along the inclination of the stepped shape of the outer peripheral edge part 102b. Therefore, the adhesive 103 is prevented from entering the sensor structure 101a, and the sensor structure 101a can be prevented from sticking due to the adhesive 103.

The above-described stepped shape can be formed at the forming step shown in FIG. 9B described in the third embodiment, by removing an area having a predetermined space from positions where the concave parts will be formed. For example, the stepped shape can be formed by forming the concave part 120a by an anisotropic wet etching with a mask material 121 which is larger than the concave part 102a for the predetermined width. Alternatively, the stepped shape can be formed by removing an area having a predetermined space from positions where the concave parts will be formed by an excimer laser.

### Other Embodiments

Although the present invention has been fully described in connection with the preferred embodiments thereof with reference to the accompanying drawings, it is to be noted that various changes and modifications will become apparent to those skilled in the art.

For example, in the first embodiment, an adhesive may be applied on the surface of the adhesion layer 21 provided on the internal surface 20b of the protective cap 20. In the second embodiment, an adhesive may be applied on the internal surface 20b of the protective cap 20. Because the adhesives trap the foreign materials P, the same effects as above described [1-6] can be obtained.

The movable structure M of the first and second embodiments is used for an acceleration sensor. However, the invention may be applied not only to the movable structure M used for the acceleration sensor but also to any movable structure used for various sensor elements (e.g., a pressure sensor and an ultrasonic sensor) and a micro machine.

The protective cap 20 of the first and second embodiments has the approximate rectangular parallelepiped box shape in which the bottom face thereof is open. However, this invention may be applied to any shaped protective cap having therein a recess portion.

In the above-described first and second embodiments, the cap attachment structure of the invention typically used for the micro device 10 and 30 including the movable structure M formed in the substrate 11 using a MEMS technique. However, the cap attachment structure may be applied to a micro device in which a movable structure is formed separately from the substrate, and the movable structure is arranged on the substrate 11. In addition, the invention may be applied not only to a micro device provided with the movable structure M but also to any protective cap which is attached and fixed to a substrate such as a hybrid IC (Integrated Circuit). Furthermore, this invention may be applied not only to a substrate but also to any shaped adherend member.

Meanwhile, in the above-described third embodiment, all the outer peripheral edge part 102b is formed into the taper shape, and in the above-described fourth embodiment, all of the outer peripheral edge part 102b is formed into the circular arc shape. However, all of the outer peripheral edge part 102b does not need to be the taper shape or the circular arc shape, and an outer portion of the outer peripheral edge part 102b can be formed in the taper shape or the circular arc shape.

FIG. 16 shows a modified example in which a portion of the outer peripheral edge part 102b on a side of the outer rim surface 102d is formed into the taper shape. In this example, the outer peripheral edge part 102b has a surface portion parallel to the sensor chip 101. Therefore, the protective cap 102 can be stably fixed to the sensor chip 101, and an adhesion between the protective cap 102 and the sensor chip 101 by the adhesive 103 is improved.

A height and a width of the portion of the outer peripheral edge part 102b which is formed into a taper shape can have any value as long as the adhesive 103 can be protruded outside from a taper shaped portion. For example, when the outer peripheral edge part 102b has a Width of approximately 1000 μm, a width of the surface portion parallel to the sensor chip 101 is approximately 200 μm, and a width of the taper-shaped portion is 800 μm. In this case, the adhesive 103 can be effectively protruded out from the taper-shaped portion.

In the third embodiment to the fifth embodiment, the acceleration sensor is used as an example of a sensor having a sensor structure in which a sticking is possible to occur. However, this invention can be used to other sensors such as a yaw rate sensor.

Such changes and modifications are to be understood as being within the scope of the present invention as defined by the appended claims.

What is claimed is:

1. A cap attachment structure comprising:
an adherend member;
a protective cap fixed to the adherend member, wherein the protective cap has an outer peripheral edge part and an internal surface for defining an inner space; and
an adhesion layer provided on the outer peripheral edge part and the internal surface of the protective cap,
wherein the protective cap is bonded and fixed to the adherend member through the adhesion layer.

2. The cap attachment structure according to claim 1,
wherein the adhesion layer is made of an adhesive which has at least one property selected from a group comprising a thermo plasticity, a thermosetting, a photo-curing, a chemical reaction-curing, and a solvent evaporation-curing.

3. The cap attachment structure according to claim 2, wherein the adhesive has a photosensitivity.

4. The cap attachment structure according to claim 1, wherein the adhesion layer on the internal surface has an adhesive function, and is provided without being cured.

5. The cap attachment structure according to claim 1, wherein the adhesion layer has an electric conductivity.

6. The cap attachment structure according to claim 1, wherein the protective cap and the adhesion layer are transparent.

7. A cap attachment structure comprising:
an adherend member; and
a protective cap made of a material having a thermal plasticity, wherein an outer peripheral edge part of the protective cap is attached to an adherend member so that the protective cap is fixed to the adherend member.

8. A cap attachment structure comprising:
an adherend member; and
a protective cap made of a material having a thermal plasticity, wherein the protective cap is fixed to the adherend member by using the thermal plasticity of the protective cap.

9. The cap attachment structure according to claim 8, wherein the protective cap has an electric conductivity.

10. The cap attachment structure according to claim 8, wherein the protective cap is transparent.

11. The cap attachment structure according to claim 1, wherein the internal surface of the protective cap is uneven to have a concavity and convexity.

12. The cap attachment structure according to claim 1, further comprising:
a movable structure arranged on a surface of the adherend member,
wherein the protective cap is fixed to the adherend member to cover the movable structure.

13. A semiconductor device comprising:
a sensor chip having a sensor structure made of a semiconductor; and
a protective cap for covering the sensor structure, the protective cap having a concave part at a position corresponding to that of the sensor structure and an outer peripheral edge part surrounding the concave part; and
an adhesive applied to the outer peripheral edge part so that the protective cap is bonded and fixed to the sensor chip through the adhesive,
wherein the outer peripheral edge part of the concave part has a first end positioned on an inner rim surface, and a second end positioned on an outer rim surface, and
wherein the first end protrudes toward the sensor chip more than the second end, and is adjacent to the sensor chip.

14. The semiconductor device according to claim 13, wherein the outer peripheral edge part has a taper shaped part.

15. The semiconductor device according to claim 14, wherein all the outer peripheral edge part is formed into a taper shape.

16. The semiconductor device according to claim 13, wherein the outer peripheral edge part is formed into a circular arc shape.

17. The semiconductor device according to claim 16, wherein the outer peripheral edge part connects the first end on the inner rim surface and the second end on the outer rim surface.

18. The semiconductor device according to claim 13, wherein the outer peripheral edge part is formed into a stepped shape.

19. A method of manufacturing a semiconductor device, which includes a sensor chip, and a protective cap for covering a sensor structure of the sensor chip,
the method comprising:
preparing a protective base member, and forming an outer peripheral edge part into a taper or circular arc shape by carrying out an isotropic etching to the protective base member with a first mask material which covers predetermined positions where concave parts will be formed;
after removing the first mask material, forming the concave parts by carrying out an etching to the protective base member with a second mask material having openings at the predetermined positions where the concave parts will be formed;
preparing a semiconductor wafer in which the sensor structure is formed;
applying an adhesive to the outer peripheral edge part;
fixing the protective base member and the semiconductor wafer through the adhesive so that the sensor structure and the concave part correspond with each other; and
dividing the semiconductor wafer and the protective base member into chip units each of which has the sensor chip and the protective cap.

20. A method of manufacturing a semiconductor device, which includes a sensor chip, and a protective cap for covering the sensor structure of the sensor chip,
the method comprising:
preparing a protective base member, and forming an outer peripheral edge parts into a stepped shape by removing an area having a predetermined space from predetermined positions where concave parts will be formed;
forming the concave parts by carrying out an etching to the protective base member with a mask material having openings at the predetermined positions where the concave parts will be formed;
preparing a semiconductor wafer in which the sensor structure is formed;
applying an adhesive to the outer peripheral edge part;
fixing the protective base member and the semiconductor wafer through the adhesive so that the sensor structure and the concave part correspond with each other; and
dividing the semiconductor wafer and the protective base member into chip units each of which has the sensor chip and the protective cap.
